(19) United States
(12) Patent Application Publication
(10) Pub. No.: US 2020/0050121 A1
(43) Pub. Date: Feb. 13, 2020

(54) TONER COMPOSITIONS

(71) Applicant: Xerox Corporation, Norwalk, CT (US)

(72) Inventors: Robert D. Bayley, Fairport, NY (US); Grazyna E. Kmiecik-Lawrynowicz, Fairport, NY (US); Maura A. Sweeney, Irondequoit, NY (US); Edward G. Zwartz, Mississauga (CA)

(21) Appl. No.: 16/102,103

(22) Filed: Aug. 13, 2018

(51) Int. Cl. G03G 9/093; G03G 9/087; G03G 9/08

(52) U.S. Cl. CPC G03G 9/09364; G03G 9/09321; G03G 9/0904; G03G 9/0821; G03G 9/08733

(57) ABSTRACT

The present disclosure provides toners and toner processes. In embodiments, a toner is provided which comprises a first resin having a weight average molecular weight of no more than about 28,000 and an onset second heat T_{g} of no more than about 50° C.; a second resin having a weight average molecular weight greater than that of the first resin; and a paraffin wax having a melting point in the range of from about 65° C. to about 95° C.

### TECHNICAL FIELD

The present disclosure relates generally to toners and toner processes, and more specifically to toners that can be fused at reduced temperatures while achieving high gloss printing.

### BACKGROUND

Numerous processes are within the purview of those skilled in the art for the preparation of toners. Emulsion aggregation (EA) is one such method. EA toners may be formed by aggregating a colorant with a latex formed by emulsion polymerization. For example, U.S. Pat. No. 5,853,943, the disclosure of which is hereby incorporated by reference in its entirety, is directed to a semi-continuous emulsion polymerization process for preparing a latex by first forming a seed polymer. Other examples of emulsion/aggregation/coalescing processes for the preparation of toners are illustrated in U.S. Pat. Nos. 5,403,693, 5,418,108, 5,364,729, and 5,346,797, the disclosures of each of which are hereby incorporated by reference in their entirety. Other processes are disclosed in U.S. Pat. Nos. 5,527,658, 5,585,215, 5,650,255, 5,650,256 and 5,501,935, the disclosures of each of which are hereby incorporated by reference in their entirety.

Methods for reducing the energy required for fusing or melting toners to a substrate, and thus reducing energy costs, are desirable. At the same time, toners which can achieve high gloss printing are also desirable. To this end, polyester EA toners have been prepared utilizing various polyester resins. Such toners can be fused at low temperatures, resulting in significant energy savings, while also achieving high gloss printing. Less expensive styrene/acrylate EA toners have also been prepared. Despite such advances, improved toners which can be produced at low cost, which can be fused at low temperatures, and which can achieve high gloss printing remain desirable.

### SUMMARY

The present disclosure provides toners and toner processes.

In one aspect, a toner is provided. In embodiments, the toner comprises a first resin having a weight average molecular weight of no more than about 28,000 and an onset second heat T_{g} of no more than about 50° C.; a second resin having a weight average molecular weight greater than that of the first resin; and a paraffin wax having a melting point in the range of from about 65° C. to about 95° C.

In another embodiment, a toner is provided which comprises a core comprising a first resin having a weight average molecular weight of no more than about 28,000; a shell over the core, the shell comprising a second resin having a weight average molecular weight greater than that of the first resin; and a wax having a melting point in the range of from about 65° C. to about 95° C.

In another embodiment, a toner is provided which comprises a core comprising a first resin comprising a polymer of styrene, acrylate and optionally, a functional monomer having carboxylic acid functionality, wherein the first resin has a weight average molecular weight in the range of from about 16,000 to about 28,000; a shell over the core, the shell comprising a second resin comprising a polymer of styrene, acrylate and optionally, a functional monomer having carboxylic acid functionality, wherein the second resin has a weight average molecular weight greater than that of the first resin and in the range of from about 30,000 to about 40,000; and a wax having a melting point in the range of from about 65° C. to about 95° C.

### DETAILED DESCRIPTION

The present disclosure provides toners having desirable fusing and gloss properties. The toner particles of the toner herein may possess a core-shell configuration, with a low molecular weight resin in the core and a higher molecular weight resin in the shell. In embodiments, the low molecular weight resin has a weight average molecular weight M_{w} of about 28,000 or less. The toner may include a low melting point wax, e.g., a low melting point paraffin wax. In embodiments, the toners of the present disclosure exhibit higher melt flow indices, indicative of higher gloss, and lower fusing temperatures as compared to toners containing a higher molecular weight resin.

### Core Resin

A variety of resins may be utilized in forming the core of the toner particles. Such resins may be made from any suitable monomers, depending upon the particular polymer to be utilized. Suitable monomers include, but are not limited to styrenes, acrylates, methacrylates, butadienes, isoprenes, acrylic acids, methacrylic acids, acrylonitriles, mixtures thereof, and the like.

In embodiments, a monomer utilized in forming the resin is a functional monomer. Suitable functional monomers include monomers having carboxylic acid functionality. In embodiments, the functional monomer is beta-carboxyethyl acrylate (β-CEA), 2-carboxyethyl methacrylate, and the like, and mixtures thereof. Other functional monomers which may be utilized include, for example, acrylic acid, methacrylic acid and its derivatives, and combinations of the foregoing.

In embodiments, the functional monomer contains a metallic ion, such as sodium, potassium and/or calcium. The metallic ion(s) may be present in an amount from about 0.001% to about 10% by weight of the functional monomer, in embodiments from about 0.5% to about 5% by weight of the functional monomer, or from about 1% to about 3% by weight of the functional monomer.

In embodiments, the resin contains at least one polymer. Exemplary polymers include styrene acrylates, styrene butadienes, styrene methacrylates, and more specifically, poly(styrene-alkyl acrylate), poly(styrene-1,3-diene), poly(styrene-alkyl methacrylate), poly (styrene-alkyl acrylate-acrylic acid), poly(styrene-1,3-diene-acrylic acid), poly (styrene-alkyl methacrylate-acrylic acid), poly(alkyl methacrylate-alkyl acrylate), poly(alkyl methacrylate-aryl acrylate), poly(aryl methacrylate-alkyl acrylate), poly(alkyl methacrylate-acrylic acid), poly(styrene-alkyl acrylate-acrylonitrile-acrylic acid), poly (styrene-1,3-diene-acrylonitrile-acrylic acid), poly(alkyl acrylate-acrylonitrile-acrylic acid), poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly (methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene), poly(styrene-propyl acrylate), poly(styrene-butyl acrylate), poly (styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylononitrile), poly(styrene-butyl acrylate-acrylonitrile-acrylic acid), poly(styrene-butadiene), poly(styrene-isoprene), poly(styrene-butyl methacrylate), poly(styrene-butyl acrylate-acrylic acid), poly(styrene-butyl methacrylate-acrylic acid), poly(butyl methacrylate-butyl acrylate), poly(butyl methacrylate-acrylic acid), poly(acrylonitrile-butyl acrylate-acrylic acid), and the like, and combinations thereof. The polymers may be block, random, or alternating copolymers. The term “alkyl” used in this paragraph may contain from about 1 to about 12 carbon atoms, from about 1 to about 10 carbons, or from about 1 to about 6 carbons.

In embodiments, the resin core contains a styrene-alkyl acrylate-β-CEA copolymer. In embodiments, the resin contains styrene-n-butyl acrylate-β-CEA copolymer. In embodiments, the resin core does not contain a polyester.

One, two, or more resins may be utilized in forming the core. In embodiments, where two or more resins are used, the resins may be in any suitable ratio (e.g., weight ratio) such as, for instance, of from about 1% (first resin)/99% (second resin) to about 99% (first resin)/l % (second resin), in embodiments from about 4% (first resin)/96% (second resin) to about 96% (first resin)/4% (second resin), or about 50% (first resin)/50% (second resin), although weight ratios outside these ranges may be utilized.

The resin utilized to form the core may have a weight average molecular weight (M_{w}) of about 28,000 or less, in embodiments, of about 26,000 or less, or of about 24,000 or less, as measured by Gel Permeation Chromatography (GPC). In other embodiments, the resin utilized to form the core has a M_{w} of from about 16,000 to about 28,000, from about 18,000 to about 26,000, from about 20,000 to about 24,000, or from about 20,000 to about 22,000.

The resin utilized to form the core may have a glass transition temperature (T_{g}) of from about 46° C. to about 54° C., in embodiments, from about 47° C. to about 53° C., or from about 48° C. to about 52° C., as measured by a differential scanning calorimeter (DSC). This T_{g} may be the onset second heat T_{g}.

The resin utilized to form the core may have a volume average particle diameter D₅₀ of from about 170 nm to about 190 nm, in embodiments, from about 172 nm to about 189 nm, or from about 175 nm to about 185 nm, as measured by a particle size analyzer such as Nanotrac™ 252 (Microtrac, Montgomeryville, Pa., USA).

In forming the toner particles, the resin described above may be utilized as a latex. The latex may be prepared utilizing any of the monomers described above in various amounts, depending upon the polymer to be utilized. In embodiments, styrene, an alkyl acrylate such as n-butyl acrylate, and optionally, a functional monomer such as β-CEA, may be utilized. Styrene may be present in an amount of from about 70% to about 99% by weight of monomers, in embodiments from about 70% to about 90% by weight of monomers, from about 70% to about 85% by weight of monomers, or from about 70% to about 80% by weight of monomers. Alkyl acrylate may be present in an amount of from about 1% to about 30% by weight of the monomers, in embodiments from about 10% to about 30% by weight of the monomers, from about 15% to about 30% by weight of monomers, or from about 20% to about 30% by weight of monomers. When present, the functional monomer may be present in an amount of from about 0.01% to about 10% by weight of the other monomers (e.g., styrene and alkyl acrylate), in embodiments from about 0.1 to about 10% by weight of the other monomers (e.g., styrene and alkyl acrylate), or from about 1% to about 5% by weight of the other monomers (e.g., styrene and alkyl acrylate).

The latex may be prepared in an aqueous phase containing one, two, or more surfactants. Surfactants which may be utilized may be ionic (i.e., anionic or cationic) surfactants or nonionic surfactants. The surfactant or surfactants may be present in various suitable amounts such as an amount of from about 0.01% to about 5% by weight of the non-functional monomers (e.g., styrene and alkyl acrylate), in embodiments of from about 0.75% to about 4% by weight of the non-functional monomers (e.g., styrene and alkyl acrylate), or from about 1% to about 3% by weight of the non-functional monomers (e.g., styrene and alkyl acrylate).

Examples of anionic surfactants include sulfates and sulfonates, disulfonates, such as sodium dodecylsulfate (SDS), sodium dodecylbenzene sulfonate, sodium dodecylnaphthalene sulfate and the like; dialkyl benzenealkyl sulfates; acids, such as palmitic acid, and NEOGEN or NEOGEN SC available from Daiichi Kogyo Seiyaku, and the like. Other suitable anionic surfactants include DOWFAX™ 2A1, an alkyldiphenyloxide disulfonate, available from The Dow Chemical Company and TAYCA POWER BN2060, a branched sodium dodecyl benzene sulfonate, available from Tayca Corporation (Japan). Mixtures of anionic surfactants may be used. Anionic surfactants may be combined with nonionic surfactants.

Examples of cationic surfactants include alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, trimethyl ammonium bromide, halide salts of quarternized polyoxyethylalkylamines, dodecylbenzyl triethyl ammonium chlorides, MIRAPOL® and ALKAQUAT® available from Alkaril Chemical Company, SANISOL® (benzalkonium chloride) available from Kao Chemicals, and the like. Mixtures of cationic surfactants may be used. Cationic surfactants may be combined with nonionic surfactants.

Examples of nonionic surfactants include polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy) ethanol, and the like. Commercially available surfactants from Rhone-Poulenc such as IGEPAL CA-210™, IGEPAL CA520™, IGEPAL CA-720™, IGEPAL CO-890™, ANTAROX 890™, IGEPAL CO-720™, IGEPAL CO-290™, IGEPAL CA-210™ and ANTAROX 897™ may be selected. Other examples of suitable nonionic surfactants include a block copolymer of polyethylene oxide and polypropylene oxide, including those commercially available as SYNPERONIC® PR/F and SYNPERONIC® PR/F 108. Mixtures of nonionic surfactants may be used.

In embodiments, a chain transfer agent such as a mercaptan or a thiol may be utilized in forming the latex. Suitable chain transfer agents include n-dodecylmercaptan (NDM), n-dodecanethiol (DDT), tert-dodecylmercaptan, 1-butanethiol, 2-butanethiol, octanethiol, mixtures thereof, and the like. Halogenated carbons such as carbon tetrabromide, carbon tetrachloride, mixtures thereof, and the like may be used as chain transfer agents. The chain transfer agents may be present in various suitable amounts, for example, from about 0.05% to about 10% by weight of the non-functional monomers (e.g., styrene and alkyl acrylate), in embodiments from about 0.1% to about 10% by weight of the non-functional monomers (e.g., styrene and alkyl acrylate), or from about 0.1% to about 5% by weight of the non-functional monomers (e.g., styrene and alkyl acrylate). As further described below, the amount of the chain transfer agent may be partitioned into portions, each portion added separately during formation of the latex in order to provide fine control over the molecular weight properties of the polymer.

In embodiments, an initiator may be utilized in forming the latex. Examples of suitable initiators include water soluble initiators, such as ammonium persulfate (APS), sodium persulfate and potassium persulfate; and organic soluble initiators including organic peroxides and azo compounds including Vazo peroxides, such as VAZO 64™, 2-methyl 2-2′-azobis propanenitrile, VAZO 88™, 2-2′-azobis isobutyramide dehydrate, and mixtures thereof. Other water-soluble initiators which may be utilized include azoamidine compounds, for example 2,2′-azobis(2-methyl-N-phenylpropionamidine) dihydrochloride, 2,2′-azobis[N-(4-chlorophenyl)-2-methylpropionamidine]di-hydrochloride, 2,2′-azobis[N-(4-hydroxyphenyl)-2-methyl-propionamidine]dihydrochloride, 2,2′-azobis[N-(4-amino-phenyl)-2-methylpropionamidine]tetrahydrochloride, 2,2′-azobis[2-methyl-N(phenylmethyl)propionamidine]dihydrochloride, 2,2′-azobis[2-methyl-N-2-propenylpropionamidine]dihydrochloride, 2,2′-azobis[N-(2-hydroxy-ethyl)2-methylpropionamidine]dihydrochloride, 2,2′-azobis[2(5-methyl-2-imidazolin-2-yl)propane]dihydrochloride, 2,2′-azobis[2-(2-imidazolin-2-yl)propane]dihydrochloride, 2,2′-azobis[2-(4,5,6,7-tetrahydro-1H-1,3-diazepin-2-yl)propane]dihydrochl-oride, 2,2′-azobis[2-(3,4,5,6-tetrahydropyrimidin-2-yl)propane]dihydrochlo-ride, 2,2′-azobis[2-(5-hydroxy-3,4,5,6-tetrahydropyrimidin-2-yl)propane]di-hydrochloride, 2,2′-azobis {2-[1-(2-hydroxyethyl)-2-imidazolin-2-yl]propane} dihydrochloride, mixtures thereof, and the like.

Initiators may be added in various suitable amounts, such as from about 0.1% to about 8% by weight of the non-functional monomers (e.g., styrene and alkyl acrylate), in embodiments from about 0.1% to about 5% by weight of the non-functional monomers (e.g., styrene and alkyl acrylate), or from about 0.2% to about 5% by weight of the non-functional monomers (e.g., styrene and alkyl acrylate).

In embodiments, the latex is prepared without a crosslinking agent in order to achieve higher gloss and lower fusing temperature. Thus, in embodiments, the resin utilized in the core is substantially non-crosslinked. The term “substantially” is used in recognition of the fact that the amount of crosslinking in the resin may not be perfectly zero, but that since no crosslinking agent is used in preparing the resin in certain embodiments, such embodiments would considered to provide resin substantially free of crosslinking.

In embodiments, the latex may be prepared by an emulsion polymerization (EP) process using a seed polymer. In such a process, reactants may be added to a suitable reactor, such as a mixing vessel. The appropriate amount of at least two to about 10 monomers, such as, about two to about three monomers, surfactant(s), chain transfer agent, if any, initiator, if any, and the like are combined in a reactor and the EP process allowed to begin. Reaction conditions selected for implementing the EP include temperatures of, for example, from about 45° C. to about 120° C., in embodiments from about 60° C. to about 90° C.

In embodiments, a surfactant solution may be prepared in the reactor. In a separate vessel, a monomer emulsion containing monomers and a first portion of a chain transfer agent may be prepared. An aliquot of the monomer emulsion may be added to the surfactant solution in the reactor. An initiator solution may be added to the reactor and conditions adjusted in order to allow seed particle formation. An additional amount of the monomer emulsion may be fed into the reactor. Next, a second portion of the chain transfer agent may be added to the remaining monomer emulsion and the mixture then fed into the reactor. Temperature of the reactor may be adjusted to obtain the desired final particle size. In embodiments, the amount of the chain transfer agent in the first portion (to form the seed particles) is greater than the amount of the chain transfer agent in the second portion (to form the final resin particles). Various ratios may be utilized, for example, from about 4:1 to about 8:1, in embodiments, from about 5:1 to about 7:1, or about 6:1.

The latex may be utilized to form the toner of the present disclosure. The toner may include other components, such as a wax, a colorant, and other additives. Such waxes, colorants, and other additives may be utilized in dispersions containing any of the surfactants described above.

### Wax

A wax may be combined with the latex described above in forming the toner particles. The wax may be present in various suitable amounts, for example, in an amount of from about 10% to about 25% by weight of the toner particles, in embodiments from about 12% to about 20% by weight of the toner particles, or from about 13% to about 18% by weight of the toner particles. The wax may be a low melting point wax and may have a melting point, for example, of from about 65° C. to about 95° C., in embodiments from about 70° C. to about 90° C., from about 75° C. to about 85° C., or from about 79° C. to about 83° C. The wax may have a weight average molecular weight (M_{w}), for example, of from about 500 to about 20,000, as measured by GPC, in embodiments from about 1,000 to about 20,000, or from about 1,000 to about 10,000. Waxes which may be utilized include, for example, mineral-based waxes and petroleum-based waxes, such as montan wax, ozokerite, ceresin wax, paraffin wax, microcrystalline wax and Fischer-Tropsch waxes, mixtures thereof, and the like. In embodiments, the wax is a paraffin wax. In embodiments, the wax is not a polyethylene wax.

### Colorants

A colorant may be combined with the latex described above in forming the toner particles. Colorants include, for example, pigments, dyes, mixtures thereof, such as mixtures of dyes, mixtures of pigments, mixtures of dyes and pigments, and the like. The colorant may be added in amounts sufficient to impart the desired, color, hue, shade, and the like. The colorant may be present in an amount of, for example, from about 0% to about 25% by weight of the toner particles, in embodiments from about 1% to about 20% by weight of the toner particles, or from about 2% to about 15% by weight of the toner particles.

Carbon black, which is available in forms, such as furnace black, thermal black, and the like is a suitable colorant. Carbon black may be used with one or more other colorants, such as a cyan colorant, to produce a desired hue.

Examples of cyan pigments include copper tetra(octadecylsulfonamido) phthalocyanine, a copper phthalocyanine colorant listed in the Color Index (CI) as CI 74160, HELIOGEN BLUE L6900™, D6840™, D7080™, D7020™, PYLAM OIL BLUE™, PYLAM OIL YELLOW™ and PIGMENT BLUE I™ available from Paul Uhlich & Co., Inc., CI Pigment Blue (PB), PB 15:3, PB 15:4, an Anthrazine Blue colorant identified as CI 69810, Special Blue X-2137, mixtures thereof, and the like.

Examples of magenta pigments include a diazo dye identified as C.I. 26050, 2,9-dimethyl-substituted quinacridone, an anthraquinone dye identified as C.I. 60710, C.I. Dispersed Red 15, CINQUASIA MAGENTA™ available from E.I. DuPont de Nemours & Co., C.I. Solvent Red 19, Pigment Red (PR) 122, PR 269, PR 185, mixtures thereof, and the like.

Examples of yellow colorants include diarylide yellow 3,3-dichlorobenzidene acetoacetanilide, a monoazo pigment identified in the Color Index as C.I. 12700, C.I. Solvent Yellow 16, a nitrophenyl amine sulfonamide identified in the Color Index as Foron Yellow SE/GLN, LEMON CHROME YELLOW DCC 1026™ CI, NOVAPERM YELLOW FGL™ from sanofi, Paliogen Yellow 152, 1560 (BASF), Lithol Fast Yellow 0991K (BASF), Paliotol Yellow 1840 (BASF), Neopen Yellow (BASF), Novoperm Yellow FG 1 (sanofi), Permanent Yellow YE 0305 (Paul Uhlich), Pigment Yellow 74, Lumogen Yellow D0790 (BASF), Sunsperse Yellow YHD 6001 (Sun Chemicals), SUCD-Yellow D1355 (BASF), Permanent Yellow FGL, Disperse Yellow, 3,2,5-dimethoxy-4-sulfonanilide phenylazo-4′-chloro-2,5-dimethoxy acetoacetanilide, mixtures thereof, and the like.

### Toner Preparation

The toner particles may be prepared by any method within the purview of one skilled in the art. Although embodiments relating to toner particle production are described below with respect to emulsion-aggregation (EA) processes, any suitable method of preparing toner particles may be used, including chemical processes, such as suspension and encapsulation processes disclosed, for example, in U.S. Pat. Nos. 5,290,654 and 5,302,486, the entire disclosures of each of which are hereby incorporated by reference in their entirety.

In embodiments, the toner particles are prepared by EA processes, such as a process that includes aggregating a mixture of a wax, a colorant, and a latex containing a core resin as described above, and then coalescing the aggregate mixture. The wax, the colorant, etc. may be utilized in an aqueous dispersion containing, for example, any of the surfactants described above. In embodiments, the mixture may be homogenized. Homogenization may be accomplished, for example, by mixing at about 600 to about 6,000 revolutions per minute.

Following preparation of the above mixture, an aggregating agent may be added to the mixture. Any suitable aggregating agent may be utilized. The aggregating agent may be an inorganic cationic coagulant, such as, for example, a polyaluminum halide, such as polyaluminum chloride (PAC) or the corresponding bromide, fluoride or iodide; a polyaluminum silicate, such as, polyaluminum sulfosilicate (PASS); or a water soluble metal salt, including, aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper chloride, copper sulfate or mixtures thereof. The aggregating agent may be added to the mixture at a temperature that is below the T_{g} of the resin.

The aggregating agent may be added to the mixture in various amounts. An amount of aggregating agent may be selected to minimize the amount of crosslinking in the toner particle and to achieve higher gloss and lower fusing temperature. In embodiments, the amount of aggregating agent is no more than about 0.17% by weight of the toner particles, in embodiments no more than about 0.16% by weight of the toner particles, or no more than about 0.15% by weight of the toner particles. In embodiments, the amount of aggregating agent is from about 0.08% to about 0.17% by weight of the toner particles, from about 0.09% to about 0.16% by weight of the toner particles, or from about 0.10% to about 0.16% by weight of the toner particles. The aggregating agent may be added in a solution of nitric acid or a similar acid. To control aggregation of the particles, the aggregating agent may be metered into the mixture over time. For example, the agent may be added incrementally to the mixture over a period of from about 5 min to about 240 min, in embodiments, from about 30 to about 200 minutes, although more or less time may be used. The addition of the aggregating agent may be accomplished with continued homogenization. The mixture may be further homogenized after addition.

The particles may be permitted to aggregate until a predetermined desired core particle size is obtained. A predetermined desired size refers to the desired particle size to be obtained as determined prior to formation, and the particle size may be monitored during the growth process. Samples may be taken during the growth process and analyzed, for example, with a Coulter Counter, for average particle size. The aggregation thus may proceed by maintaining the mixture, for example, at elevated temperature, or slowly raising the temperature to, for example, from about 40° C. to about 100° C., and holding the mixture at this temperature for a time, for example, of from about 0.5 hours to about 10 hours, while maintaining stirring, to provide the aggregated particles. Once the predetermined desired particle size is reached, the growth process is halted. The volume average particle diameter D₅₀ of the particles may be, for example, from about 3 μm to about 10 μm, in embodiments, from about 3 μm to about 8 μm, or from about 3 μm to about 6 μm.

### Shell Resin

In embodiments, after aggregation, but prior to coalescence, a resin coating may be applied to the aggregated particles to form a shell thereover. Any resin described above with respect to the core resin may be utilized for the shell resin. In embodiments, the resin utilized for the shell contains a styrene-alkyl acrylate-β-CEA copolymer. In embodiments, the resin contains styrene-n-butyl acrylate-β-CEA copolymer. The shell resin may be utilized in the form of a latex as described above with respect to the core resin. The shell latex may be formed as described above with respect to the core latex. Thus, various amounts of monomers may be used to prepare the shell latex. For example, styrene may be present in an amount of from about 70% to about 90% by weight of monomers, in embodiments from about 75% to about 85% by weight of monomers, or from about 77% to about 83% by weight of monomers. Alkyl acrylate may be present in an amount of from about 1% to about 30% by weight of the monomers, in embodiments from about 10% to about 30% by weight of the monomers, or from about 15% to about 20% by weight of monomers. When present, the functional monomer may be present in the amounts described above with respect to the core latex.

In embodiments, a crosslinking agent may be utilized in forming the shell latex. Exemplary crosslinking agents include decanediol diacrylate (ADOD), trimethylolpropane, pentaerythritol, trimellitic acid, pyromellitic acid and mixtures thereof. Crosslinking agents may be added in suitable amounts, such as from about 0.01% to about 2% by weight of the non-functional monomers (e.g., styrene and alkyl acrylate), in embodiments from about 0.1% to about 2% by weight of the non-functional monomers (e.g., styrene and alkyl acrylate), or from about 0.1% to about 0.5% by weight of the monomers non-functional monomers (e.g., styrene and alkyl acrylate).

In addition, in embodiments of forming the shell latex, the amount of the chain transfer agent utilized in the first portion (to form the seed particles) is about the same as the amount of the chain transfer agent in the second portion (to form the final resin particles).

The shell resin may be applied to the aggregated particles by any method within the purview of those skilled in the art.

In embodiments, the resin utilized to form the shell may have a weight average molecular weight (M_{w}) which is greater than the M_{w} of the resin utilized to form the core. In embodiments, the resin utilized to form the shell may have a M_{w} of about 30,000 or more, in embodiments of about 32,000 or more, or of about 34,000 or more, as measured by GPC. In embodiments, the resin utilized to form the shell has a M_{w} of from about 30,000 to about 40,000, in embodiments, from about 31,000 to about 38,000, or from about 32,000 to about 36,000. In embodiments, the resin utilized to form the shell may have a glass transition temperature (T_{g}) which is greater than the T_{g} of the resin utilized to form the core. In embodiments, the resin utilized to form the shell may have a T_{g} of from about 56° C. to about 64° C., in embodiments from about 57° C. to about 63° C., or from about 58° C. to about 62° C., as measured by DSC. This T_{g} may be the onset second heat T_{g}. The resin utilized to form the shell may have a volume average particle diameter D₅₀ of from about 160 nm to about 180 nm, in embodiments, from about 162 nm to about 179 nm, or from about 165 nm to about 175 nm, as measured by a particle size analyzer such as Nanotrac™ 252 (Microtrac, Montgomeryville, Pa., USA).

Once the desired final size of the toner particles is achieved, the pH of the mixture may be adjusted with a pH control agent to a value of, for example, from about 3 to about 10, in embodiments from about 4 to about 9, or from about 4 to about 6. Suitable pH control agents include various bases including alkali metal hydroxides such as, for example, sodium hydroxide, potassium hydroxide, ammonium hydroxide, combinations thereof, and the like. A chelating agent may also be added to enable reduction in particle crosslinking. Various suitable chelating agents may be used, such as ethylenediaminetetraacetic acid (EDTA), salts of EDTA, tartaric acid, gluconal, hydroxyl-2,2′iminodisuccinic acid (HIDS), dicarboxylmethyl glutamic acid (GLDA), methyl glycidyl diacetic acid (MGDA), hydroxydiethyliminodiacetic acid (HIDA), sodium gluconate, potassium citrate, sodium citrate, nitrotriacetate salt, humic acid, fulvic acid; alkali metal salts of EDTA, gluconic acid, oxalic acid, polyacrylates, sugar acrylates, citric acid, polyaspartic acid, diethylenetriamine pentaacetate, 3-hydroxy-4-pyridinone, dopamine, eucalyptus, iminodisuccinic acid, ethylenediaminedisuccinate, polysaccharide, sodium ethylenedinitrilotetraacetate, thiamine pyrophosphate, famesyl pyrophosphate, 2-aminoethylpyrophosphate, hydroxyl ethylidene-1,1-diphosphonic acid, aminotrimethylenephosphonic acid, diethylene triaminepentamethylene phosphonic acid, ethylenediamine tetramethylene phosphonic acid, mixtures thereof, and the like. Various suitable amounts of the chelating agent may be used, for example, in an amount of from about 0.1% to about 1% by weight of the toner particles, in embodiments, from about 0.2% to about 0.7% by weight of the toner particles, or from about 0.3% to about 0.5% by weight of the toner particles.

### Coalescence

Following aggregation and application of the shell, the particles may then be coalesced to the desired final shape, the coalescence being achieved, by, for example, heating the mixture to a temperature of from about 80° C. to about 110° C., in embodiments from about 85° C. to about 100° C., which may be at or above the glass transition temperature of the resins utilized to form the toner particles. The particular selection of temperature is a function of the resins used. The mixture may be stirred, for example, at from about 100 rpm to about 1,000 rpm, in embodiments from about 150 rpm to about 800 rpm. Coalescence may be accomplished over a period of time, for example, of from about 1 minute to about 10 hours, in embodiments from about 5 minutes to about 5 hours. The particles may be coalesced until a desired circularity is achieved. During coalescence, pH control agents including various acids such as nitric acid may be used to adjust the pH, for example, to a value of from about 3 to about 10, in embodiments from about 4 to about 9, or from about 4 to about 6.

After coalescence, the mixture may be cooled to room temperature, such as from about 20° C. to about 25° C. The cooling may be rapid or slow as desired. A suitable cooling method may include introducing cold water to a jacket around the reactor. During cooling, pH control agents may be used to adjust the pH, for example, to a value of from about 3 to about 10, in embodiments, from about 4 to about 9, or from about 5 to about 7. After cooling, the toner particles optionally may be washed with water and then dried. Drying may be accomplished by any suitable method including, for example, freeze-drying.

The toner particles may contain various relative amounts of the core resin and the shell resin. In embodiments, the core resin is present in an amount of no more than about 60% by weight of the toner particles, in embodiments no more than about 55% by weight of the toner particles, or no more than about 52% by weight of the toner particles. In embodiments, the shell resin is present in an amount of at least about 20% by weight of the toner particles, in embodiments at least about 23% by weight of the toner particles, or at least about 25% by weight of the toner particles. In embodiments, the core resin is present in an amount of from about 40% to about 60% by weight of the toner particles, in embodiments from about 42% to about 58% by weight of the toner particles, or from about 45% to about 55% by weight of the toner particles. In embodiments, the shell resin is present in an amount of from about 20% to about 40% by weight of the toner particles, in embodiments from about 22% to about 38% by weight of the toner particles, or from about 25% to about 35% by weight of the toner particles.

The toner particles may contain various total amounts of resin, for example, in an amount of from about 60% to about 95% by weight of the toner particles, in embodiments, from about 65% to about 90% by weight of the toner particles, or from about 75% to about 85% by weight of the toner particles.

### Additives

The toner may further contain a variety of additives to enhance the properties of the toner. The toner may include charge additives in amounts of, for example, from about 0.1% to about 10% by weight of the toner, in embodiments from about 0.5% to about 7% by weight of the toner. Suitable charge additives include alkyl pyridinium halides, bisulfates, the charge control additives of U.S. Pat. Nos. 3,944,493; 4,007,293; 4,079,014; 4,394,430 and 4,560,635, the entire disclosures of each of which are hereby incorporated by reference in their entirety, negative charge enhancing additives like aluminum complexes, any other charge additives, mixtures thereof, and the like.

The toner may contain surface additives. Surface additives that can be added to the toner particles after washing or drying include, for example, metal salts, metal salts of fatty acids, colloidal silicas, metal oxides, strontium titanates, mixtures thereof, and the like, which each may be present in an amount of from about 0.1% to about 10% by weight of the toner, in embodiments from about 0.5% to about 7% by weight of the toner. Examples of such additives include, for example, those disclosed in U.S. Pat. Nos. 3,590,000, 3,720,617, 3,655,374 and 3,983,045, the disclosures of each of which are hereby incorporated by reference in their entirety. Other additives include zinc stearate and AEROSIL R972® available from Degussa. The coated silicas of U.S. Pat. Nos. 6,190,815 and 6,004,714, the disclosures of each of which are hereby incorporated by reference in their entirety, can also be selected in amounts, for example, of from about 0.05% to about 5% by weight of the toner, in embodiments from about 0.1% to about 2% by weight of the toner, which additives can be added during the aggregation process or blended into the formed toner particles.

In embodiments, toners of the present disclosure may be utilized as high gloss low melt (HGLM) toners. In embodiments, the dry toner particles, exclusive of external surface additives, have the following characteristics:

(1) Volume average particle diameter D₅₀ of from about 3 m to about 15 μm, in embodiments from about 4 μm to about 10 μm, or from about 5 μm to about 8 μm.

(2) Number Average Geometric Size Distribution (GSDn) and/or Volume Average Geometric Size Distribution (GSDv) of from about 1.05 to about 1.55, in embodiments from about 1.1 to about 1.4, or from about 1.1 to about 1.3.

(3) Circularity of from about 0.90 to about 1.00, in embodiments from about 0.92 to about 0.99, or from about 0.95 to about 0.98 (as measured with, for example, a Sysmex 3000).

(4) Glass transition temperature (T_{g}) of from about 40° C. to 60° C., in embodiments from about 42° C. to 58° C., in embodiments from about 45° C. to about 55° C. (as measured with, for example, DSC). This T_{g} may be the onset second heat T_{g}.

As noted above, the characteristics of the toner particles may be determined by any suitable technique and apparatus. With respect to volume average particle diameter D₅₀, GSDv, and GSDn, these characteristics may be measured by means of a measuring instrument such as a Nanotrac™ 252, operated in accordance with the manufacturer's instructions.

In embodiments, the dry toner particles, exclusive of external surface additives, may be characterized by a melt flow index (MFI). The melt flow index (MFI) of toner particles may be measured by methods within the purview of those skilled in the art, including the use of a plastometer. For example, the MFI of the toner particles may be measured on a Tinius Olsen extrusion plastometer at about 125° C. with about 5 kilograms load force. Samples may then be dispensed into the heated barrel of the melt indexer, equilibrated for an appropriate time, in embodiments from about five minutes to about seven minutes, and then the load force of about 5 kg may be applied to the melt indexer's piston. The applied load on the piston forces the molten sample out a predetermined orifice opening. The time for the test may be determined when the piston traveled one inch. The melt flow may be calculated by the use of the time, distance, and weight volume extracted during the testing procedure.

MFI as used herein thus includes, in embodiments, the weight of a toner (in grams) which passes through an orifice of length L and diameter D in a 10 minute period with a specified applied load (as noted above, 5 kg) at a temperature (as noted above, 125° C.). An MFI unit of 1 thus indicates that only 1 gram of the toner passed through the orifice under the specified conditions in 10 minutes time, “MFI units” as used herein thus refers to units of grams per 10 minutes.

Toner particles of the present disclosure subjected to this procedure may have varying MFI depending on the pigment utilized to form the toner particle. In embodiments, black/cyan toner particles have an MFI of at least about 80, at least about 90, at least about 95, at least about 98, or at least about 100. In embodiments, black/cyan toner particles have an MFI of from about 80 to about 120, from about 80 to about 120, from about 90 to about 110, or from about 95 to about 110.

In embodiments, the dry toner particles, inclusive of external surface additives, may be characterized by a minimum fixing temperature (MFT). The MFT measurement may be carried out using a tape peel method. When using this method, an image is fused onto a substrate at different temperatures and the image density is measured. A piece of tape is placed on a specific location of the various images and then peeled off. The image density of the area where the tape was peeled off from is measured. The MFT is determined as the lowest temperature at which the ratio of the image density after peeling off the tape and before peeling it off is 0.90. Toner particles of the present disclosure subjected to this procedure may have a MFT of no more than about 140° C., no more than about 138° C., no more than about 136° C., or no more than about 134° C. In embodiments, toner particles have a MFT of from about 130° C. to about 140° C., in embodiments from about 132° C. to about 138° C.

### Developers and Carriers

The toners may be formulated into a developer composition. Developer compositions can be prepared by mixing the toners of the present disclosure with known carrier particles, including coated carriers, such as steel, ferrites, and the like. Such carriers include those disclosed in U.S. Pat. Nos. 4,937,166 and 4,935,326, the entire disclosures of each of which are incorporated herein by reference. The carriers may be present from about 2% to about 8% by weight of the toner, in embodiments from about 4% to about 6% by weight of the toner. The carrier particles can also include a core with a polymer coating thereover, such as polymethylmethacrylate (PMMA), having dispersed therein a conductive component like conductive carbon black. Carrier coatings include silicone resins such as methyl silsesquioxanes, fluoropolymers such as polyvinylidiene fluoride, mixtures of resins not in close proximity in the triboelectric series such as polyvinylidiene fluoride and acrylics, thermosetting resins such as acrylics, mixtures thereof and other known components.

The toners may be incorporated into a number of devices ranging from enclosures or vessels, such as, a vial, a bottle, a flexible container, such as a bag or a package, and the like, to devices that serve more than a storage function. The toners may be incorporated into devices dedicated, for example, to delivering the same for a purpose, such as, forming an image. Hence, particularized toner delivery devices may be utilized, see, for example, U.S. Pat. No. 7,822,370. Such devices include cartridges, tanks, reservoirs and the like, and may be replaceable, disposable or reusable. Such a device may comprise a storage portion; a dispensing or delivery portion; and the like; along with various ports or openings to enable toner addition to and removal from the device; an optional portion for monitoring amount of toner in the device; formed or shaped portions to enable sitting and seating of the device in, for example, an imaging device; and the like. A toner of interest may be included in a device dedicated to delivery thereof, for example, for recharging or refilling toner in an imaging device component, such as, a cartridge, in need of toner, see, for example, U.S. Pat. No. 7,817,944, wherein the imaging device component may be replaceable or reusable.

### Imaging

The toners may be used for electrostatographic or xerographic processes, including those disclosed in U.S. Pat. No. 4,295,990, the disclosure of which is hereby incorporated by reference in entirety. In embodiments, any known type of image development system may be used in an image developing device, including, for example, magnetic brush development, jumping single component development, hybrid scavengeless development (HSD) and the like. Those and similar development systems are within the purview of those skilled in the art.

Imaging processes include, for example, preparing an image with a xerographic device including a charging component, an imaging component, a photoconductive component, a developing component, a transfer component, and a fusing component. In embodiments, the development component may include a developer prepared by mixing a carrier with a toner composition described herein. The xerographic device may include a high speed printer, a black and white high speed printer, a color printer, and the like.

Once the image is formed with toners/developers via a suitable image development method such as any one of the aforementioned methods, the image may then be transferred to an image receiving medium such as paper and the like. In embodiments, the toners may be used in developing an image in an image-developing device utilizing a fuser roll member. Fuser roll members are contact fusing devices that are within the purview of those skilled in the art, in which heat and pressure from the roll may be used to fuse the toner to the image-receiving medium. In embodiments, the fuser member may be heated to a temperature above the fusing temperature of the toner, for example to temperatures of from about 70° C. to about 160° C., in embodiments from about 80° C. to about 150° C., in other embodiments from about 90° C. to about 140° C., after or during melting onto the image receiving substrate.

### EXAMPLES

The following Examples are being submitted to further define various species of the present disclosure. These Examples are intended to be illustrative only and are not intended to limit the scope of the present disclosure. Also, parts and percentages are by weight unless otherwise indicated. As used herein, “room temperature” refers to a temperature of from about 20° C. to about 25° C.

### Example 1

A control core latex was prepared by in-situ seeded semi-continuous emulsion copolymerization of styrene and n-butyl acrylate (nBA) with functional monomer beta-CarboxyEthyl Acrylate (beta-CEA) at 75° C. The reagents and amounts are provided in Table 1. Functional monomer beta-CEA, crosslinking agent Alkanediol Di(meth)Acrylate (A-DOD), DOWFAX™ 2A1 (an alkyldiphenyloxide disulfonate surfactant from Dow Chemical), ammonium persulfate initiator (APS) and chain transfer agent n-dodecylmercaptan (NDM) are all measured in amounts of pph per total weight of styrene and n-butyl acrylate.

To an 8-liter jacketed glass reactor fitted with a nitrogen inlet and outlet, internal cooling coil, thermometer and double P-4 impeller set at 200 rpm, 1648.4 g of distilled water and 8.25 g of DOWFAX™ 2A1 was charged in and deaerated for ˜60 minutes, with a continuous nitrogen flow, while the temperature was raised to 75° C. A monomer emulsion was prepared in a 4-liter stainless mixing vessel, with a nitrogen inlet and outlet, by agitating a monomer mixture (1477.41 g of styrene, 453.9 g of nBA, 6.76 g A-DOD, 57.85 g of beta-CEA and 13.19 g of NDM) with an aqueous solution (32.88 g of DOWFAX™ 2A1 (47% aq.) and 915.04 g of distilled water) at rpm of between 100 and 450 at room temperature, under a nitrogen gas flow and deaerated. A 5 wt % of seed monomer emulsion was taken from the monomer emulsion and added to the 8 liter reactor and was stirred for ˜20 minutes at 75° C. An initiator solution prepared from 28.93 g of APS in 252.3 grams of distilled water was added to the 8 liter reactor over 20 minutes. Stirring continued for 20 min to allow seed particle formation. The first half of the remaining monomer emulsion was then fed into the reactor over 120 minutes. A latex core particle size of 140.5 nm D₅₀, measured on a Nanotrac™ 252, was formed at this point.

Next, 14.29 grams of NDM were added into the remaining monomer emulsion, and stirred at about 300 rpm for 5 minutes. Then, the new monomer emulsion was fed into the reactor over 90 minutes. At the conclusion of the monomer feed, the emulsion was post-heated at 75° C. for 1 hour, raised over time to ˜85° C. for a total of 3 hours, under a flow of nitrogen and then cooled to room temperature. This final latex had an average particle size of 165 nm D₅₀, measured on a Nanotrac™ 252, M_{w} of 35.6K (GPC), and a T_{g} onset second heat of 51° C., with about 42 percent solids. This latex was very stable and sediment-free.

### Example 2

A low molecular weight (LMW) core latex was synthesized in a 2 gallon lab reactor by semi-continuous emulsion polymerization process as provided in Example 1 with the reagents shown in Table 1. This final latex had an average particle size of 179.5 nm D₅₀, as measured on a Nanotrac™ 252, M_{w} of 22.3K (GPC) and a T_{g} onset second heat of 48.1° C., with about 41.5% solids. The latex was very stable and sediment-free.

TABLE 1
Core Latex.

| | Example 1 | Example 2 |
|---|---|---|
| | Core Latex Control | LMW Core Latex |
| Reagent | | |
| Styrene (St) (%) | 76.5 | 76.5 |
| nBA (%) | 23.5 | 23.5 |
| beta-CEA (pph) | 3.0 | 3.0 |
| ADOD (pph) | 0.35 | 0.0 |
| NDM #1 (pph) | 0.68 | 1.5 |
| NDM #2 (pph) | 0.74 | 0.25 |
| Dowfax 2AI (pph) | 1.0 | 1.0 |
| APS (pph) | 1.5 | 1.5 |
| Seed % | 5 | 5 |
| Properties | | |
| PS (nm) Mictrotrac | 165 | 179.5 |
| Nanotrac ™252 | | |
| M_{w} (K) | 35.6 | 22.3 |
| T_{g} (° C.) onset | 51.0 | 48.1 |
| second heat | | |

As can be discerned from Table 1, the resin of Example 2, averaged about 179 nm in size with a M_{w} of about 22,300. The resin has a T_{g} onset second heat of about 48.1° C. On the other hand, the control resin which included the crosslinking agent, A-DOD, had a particle size of about 165 nm, a M_{w} of about 35,600 and a higher T_{g} onset second heat of 51.0° C.

### Example 3

The materials and method of Example 2 were duplicated and a resin with properties substantially the same as provided in Table 1 was obtained with particle size slightly larger at 183 nm, M_{w} of 22.4K (GPC) and T_{g} onset second heat of 49.0° C.

### Example 4

A control shell latex was synthesized in a 2 gallon lab reactor by semi-continuous emulsion polymerization as provided in Example 1 with the reagents set forth in Table 2. The properties of the control shell latex are also provided in Table 2.

### Example 5

A low molecular weight shell latex was synthesized in a 2 gallon lab reactor by semi-continuous emulsion polymerization as provided in Example 1 with the reagents set forth in Table 2. The properties of the low molecular weight shell latex are also provided in Table 2.

TABLE 2
Shell Latex.

| | Example 4 | Example 5 |
|---|---|---|
| | Shell Latex Control | LMW Shell Latex |
| Reagent | | |
| Styrene (St) (%) | 81.7 | 82.7 |
| nBA (%) | 18.3 | 17.3 |
| beta-CEA (pph) | 3 | 3 |
| ADOD (pph) | 0.35 | 0 |
| NDM #1 (pph) | 0.71 | 1.5 |
| NDM #2 (pph) | 0.73 | 0.25 |
| Dowfax 2AI (pph) | 1 | 1 |
| APS (pph) | 1.5 | 1.5 |
| Seed % | 5 | 5 |
| Properties | | |
| PS (nm) Microtrac | 170 | 170.5 |
| Nanotrac 252 | | |
| M_{w} (K) | 35.0 | 23.7 |
| T_{g} (° C.) onset | 59.0 | 59.3 |
| second heat | | |

As can be discerned from Table 2, the resin of Example 5, averaged about 171 nm in size with a molecular weight M_{w} of about 22,700 and a T_{g} onset second heat of about 59.3° C. On the other hand, the control resin which included the crosslinking agent, A-DOD, had a particle size of about 170 nm, a M_{w} of about 35,000 and a T_{g} onset second heat of 59.0° C.

### Example 6

To a 2 liter jacketed glass lab reactor were added about 21.6 parts by weight of a LMW core latex prepared according to Example 2, about 4.3 parts by weight of a Regal 330 black pigment dispersion, about 1.2 parts by weight of a Sun PB 15:3 pigment dispersion (Sun Chemicals Co.), about 9.1 parts by weight of a paraffin wax dispersion and about 51.5 parts by weight of distilled water. The melting point of the paraffin wax was about 81° C. The components were mixed by a homogenizer for about 2 minutes at about 4000 rpm. With continued homogenization, a separate mixture of about 0.24 parts by weight of poly(aluminum chloride) (PAC) (Asada Co.) in about 30 parts by weight of 0.02 M of HNO₃ was added drop-wise into the reactor. After PAC addition, the resulting viscous slurry was homogenized further at about 20° C. for about 20 minutes at about 4000 rpm. The homogenizer then was removed and replaced with a stainless steel 45° pitch semi-axial flow impeller and stirred continuously at about 300 to 350 rpm, while raising the temperature of the contents of the reactor to about 51° C. The batch was held at that temperature until a core particle size of about 5.5 μm was achieved.

A shell was applied to the core by the following process. While stirring continuously at about 300 rpm, about 11.9 parts by weight of a shell latex prepared according to Example 4 (Control) was added drop-wise over a period of about 10 minutes to the reactor containing the core particles. After addition of the shell latex, the resulting particle slurry was stirred for about 20 minutes, at which time about 0.17 parts of Na-EDTA and a sufficient amount of 1 M NaOH were added to the slurry to adjust pH of the slurry to about 5.3. After pH adjustment, the stirrer speed was lowered to about 160 rpm for an additional 10 minutes. At the end of the 10 minutes, the bath temperature was adjusted to about 92° C. to heat the slurry to about 90° C. During the temperature increase, the pH of the slurry was adjusted to about 5.3 by addition of a sufficient amount of a 0.3 M HNO₃ solution at about 80° C. The slurry temperature then was allowed to increase to about 90° C. and was maintained at 90° C. to complete coalescence to the desired circularity of about 0.975. At that time, a sufficient amount of 1 M NaOH was added to the particle slurry to adjust the pH to about 6.9 and the slurry was immediately cooled to about 63° C. On reaching 63° C., the particle slurry again was pH adjusted with a sufficient amount of 1 M NaOH to obtain a pH of about 8.8, followed by immediate cooling to about 20° C. to 35° C. The toner particles were collected by filtration, washed several times and freeze dried to remove water.

The resulting particles had an average diameter of 5.65 μm, a GSDᵥ of 1.21, a GSDₙ of 1.22 and a circularity of 0.974 (as measured by a SYSMEX 3000). The T_{g} onset second heat of the particles was 50.3° C., which is lower than the 54.3° C. T_{g} of a control toner (Example 7) prepared with polyethylene wax, see Table 3.

### Example 7

A control toner was made using the control core latex of Example 1, polyethylene wax, and the control shell latex of Example 4. The polyethylene wax had a melting point of about 104° C. The final particle size was 5.65 μm and particle circularity was 0.974 (as measured by Sysmex 3000). Table 3 provides a comparison of the control toner with the toner of Example 6 containing a LMW core latex.

TABLE 3
Toner Comparison.

| | Example 7 | Example 6 |
|---|---|---|
| | Control Toner | Toner with LMW Core Latex |
| Component | | |
| Core Latex | 36K/51° C. T_{g} | 22K/48° C. T_{g} |
| | (Example 1) | (Example 2) |
| Shell Latex | 35K/59° C. T_{g} | 35K/59° C. T_{g} |
| | (Example 4) | (Example 4) |
| Shell (%) | 28 | 28 |
| Wax | Polyethylene | Paraffin |
| Wax (%) | 10 | 16 |
| Black/Cyan (%) | 6.5/1 | 5/1 |
| PAC (pph) | 0.18 | 0.14 |
| EDTA (%) | 0.94 | 0.4 |
| Properties | | |
| MFI (melt flow index) | 29 | 104 |
| (125° C./5 kg) | | |
| T_{g} (onset | 48.3 | 48.2 |
| second heat) (° C.) | | |
| MFT (minimum fixing | 145 | 134 |
| temperature) (° C.) | | |

The toner of Example 6 demonstrated significant improvement in flow properties as compared to the control toner of Example 7, for example, with a melt flow index (MFI) @125° C./5 kg of 104 as compared to 29 for the control toner. This is indicative of improved gloss and lower fusing temperature. In addition, the MFT of the toner of Example 6 was significantly lower (134° C.) as compared to the MFT of the control toner (145° C.). The MFI and MFT values were measured as described above.

It will be appreciated that variants of the above-disclosed and other features and functions or alternatives thereof, may be combined into many other different systems or applications. Various presently unforeseen or unanticipated alternatives, modifications, variations or improvements therein may be subsequently made by those skilled in the art, which are also intended to be encompassed by the following claims.

1. A toner comprising:
a first resin having a weight average molecular weight of no more than about 28,000 and an onset second heat T_{g} of no more than about 50° C.;
a second resin having a weight average molecular weight greater than that of the first resin; and
a paraffin wax having a melting point in the range of from about 65° C. to about 95° C.,
wherein the toner does not comprise a polyester.

2. The toner of claim 1, wherein the first resin has a weight average molecular weight of from about 16,000 to about 28,000.

3. The toner of claim 2, wherein the first resin has a weight average molecular weight of from about 20,000 to about 24,000.

4. The toner of claim 1, wherein the second resin has a weight average molecular weight of about 30,000 or more.

5. The toner of claim 4, wherein the second resin has a weight average molecular weight of from about 30,000 to about 40,000.

6. The toner of claim 5, wherein the second resin has a weight average molecular weight of from about 33,000 to about 37,000.

7. The toner of claim 1, wherein the onset second heat T_{g} of the first resin is in the range of from about 45° C. to about 50° C. and further wherein the second resin has an onset second heat T_{g} greater than that of the first resin and in the range of from about 55° C. to about 65° C.

8. The toner of claim 1, wherein the first resin, the second resin, or both comprise a polymer of monomers selected from styrenes, acrylates, methacrylates, butadienes, isoprenes, acrylic acids, methacrylic acids, acrylonitriles, functional monomers having carboxylic acid functionality, and combinations thereof.

9. The toner of claim 1, wherein the first resin, the second resin, or both comprise poly(styrene-alkyl acrylate-β-CEA).

10. The toner of claim 1, wherein the first resin is substantially non-crosslinked and the second resin is crosslinked.

11. The toner of claim 1, further comprising a colorant.

12. The toner of claim 1, further comprising an additive selected from the group consisting of silica, titania, and mixtures thereof.

13. The toner of claim 1, further comprising a core comprising the first resin and a shell over the core, the shell comprising the second resin.

14. The toner of claim 1, wherein the toner is characterized by one or more of the following properties: a melt flow index (MFI) for the toner comprising a black/cyan colorant of from about 80 g to about 120 g per about 10 minutes at a temperature of about 125° C. and a load force of about 5 kg; and a minimum fix temperature (MFT) of from about 130° C. to about 140° C.

15. A toner comprising:
a core comprising a first resin having a weight average molecular weight of no more than about 28,000;
a shell over the core, the shell comprising a second resin having a weight average molecular weight greater than that of the first resin; and
a wax having a melting point in the range of from about 65° C. to about 95° C.,
wherein the core does not comprise a polyester.

16. The toner of claim 15, wherein the first resin comprises a polymer of styrene, acrylate and optionally, a functional monomer having carboxylic acid functionality and the second resin comprises a polymer of styrene, acrylate and optionally, a functional monomer having carboxylic acid functionality.

17. The toner of claim 16, wherein the first resin has a weight average molecular weight in the range of from about 16,000 to about 28,000 and further wherein the second resin has a weight average molecular weight of about 30,000 or more.

18. The toner of claim 16, wherein the first resin and the second resin each comprise poly(styrene-alkyl acrylate-β-CEA).

19. The toner of claim 16, wherein the wax is a paraffin wax.

20. A toner comprising:
a core comprising a first resin comprising a polymer of styrene, acrylate and optionally, a functional monomer having carboxylic acid functionality, wherein the first resin has a weight average molecular weight in the range of from about 16,000 to about 28,000;
a shell over the core, the shell comprising a second resin comprising a polymer of styrene, acrylate and optionally, a functional monomer having carboxylic acid functionality, wherein the second resin has a weight average molecular weight greater than that of the first resin and in the range of from about 30,000 to about 40,000; and
a wax having a melting point in the range of from about 65° C. to about 95° C.,
wherein the core does not comprise a polyester.

21. The toner of claim 15, wherein the toner does not comprise a polyester.

22. The toner of claim 15, further comprising a colorant.

23. The toner of claim 20, wherein the toner does not comprise a polyester.

24. The toner of claim 20, further comprising a colorant.
